(19) United States
(12) Patent Application Publication
(10) Pub. No.: US 2010/0180321 A1
(43) Pub. Date: Jul. 15, 2010

(54) SECURITY SYSTEM AND METHOD FOR SECURING THE INTEGRITY OF AT LEAST ONE ARRANGEMENT COMPRISING MULTIPLE DEVICES

(75) Inventors: Frank Graeber, Seester (DE); Hauke Meyn, Krempermoor (DE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 11/993,662

(22) PCT Filed: Jun. 23, 2006
(86) PCT No.: PCT/IB06/52056

§ 371 Date: Dec. 21, 2007

(30) Foreign Application Priority Data
Jun. 29, 2005 (EP) 05105808.9

(51) Int. Cl. G06F 21/00

(52) U.S. Cl. 726/4; 726/3

(57) ABSTRACT

In order to provide a security system (100; 100′) for securing the integrity of at least one arrangement comprising multiple devices (10, 12; 10a, 12a, 12b, 12c), for example of at least one network and/or of at least one computer system, wherein manipulation of the arrangement comprising these multiple components or devices (10, 12; 10a, 12a, 12b, 12c) is prevented, it is proposed that the devices (10, 12; 10a, 12a, 12b, 12c) communicate with each other, in particular by exchanging messages (20) between and among each other, that each device (10, 12; 10a, 12a, 12b, 12c) comprises at least one respective security unit (30, 32) [a] for performing at least one authentication by means of exchanged messages (20) and [b.i] in case of a valid authentication for enabling operation of the respective device (10; 10a) and/or of at least one of the other devices (12; 12a, 12b, 12c) and [b.ii] otherwise, in particular in case of an invalid authentication, for disabling operation of the respective device (10; 10a) and/or of at least one of the other devices (12; 12a, 12b, 12c) and/or—of at least one undefined and/or unauthorized device (14), in particular of at least one device comprising no such security unit (30, 32).

The present invention relates to a security system as well as to a method for securing the integrity of at least one arrangement comprising multiple devices, for example of at least one network and/or of at least one computer system.

According to the prior art open multiple device systems or complex systems, like networks, computers comprising for example computer main boards with card slots and plug-in cards, mobile phones, etc. are not protected against any kind of manipulation, i.e. against insertion or removal of arbitrary components. Thus, users are permitted to remove plug-in cards from and to insert plug-in cards into multiple device systems as they like.

However, there are cases in which system providers want to assure the integrity of their system:

As a first example, the usage of undesired network access devices in a defined network ought to be avoided. In this case, only authorized network adapter cards shall work in a defined network in order to avoid the use of illegal network adapter cards, i.e. illegal copies of network adapter cards.

As a second example, the usage of undesired plug-in cards in a computer main board ought to be avoided. In this case, only authorized plug-in cards shall work in a main board of a personal computer (PC).

As a third example, the illegal usage of plug-in cards in undefined personal computer systems ought to be prevented. In this case, a certain plug-in card must not work in an unauthorized personal computer system.

In prior art document US 2003/0231649 A1 a dual purpose method and an apparatus for performing network interface and security transactions is depicted; in particular, it is described how to encrypt data packets to be exchanged over a network channel. However, a mutual authentication, for instance of the network endpoints, is not disclosed.

How to securely define or securely control the access permissions for users for executing, reading and/or writing on a computer system is described in prior art document WO 96/42057 A1. However, the disclosure of prior art document WO 96/42057 A1 does not apply to the entire computer but only to the resources of the computer.

In prior art document U.S. Pat. No. 4,757,533 it is disclosed how to ensure data integrity and/or security of user inputs and user data storage of a personal computer wherein the system is interrupted by a file by very specific deactivation. Moreover, a way of requiring an authentication of the user before file access can be executed is disclosed.

A computer system being protected by using a personalized smart card is described in prior art document WO 02/33522 A1. Basically, the B[asic]I[nput/]O[utput]S[ystem] of the computer system does not work if the user has not the proper personalized smart card.

Finally, a device and a method for preventing the usage of stolen computer hardware in another system are depicted in prior art document U.S. Pat. No. 6,594,765 B2; in particular, it is described to use a remote server computer continuously communicating to devices with embedded security units or agents to verify the integrity of the system.

The remote server computer advises the embedded agent to block the device which is part of the system; this means that the security profile is only stored in the remote server.

Thus, the device and the method according to prior art document U.S. Pat. No. 6, 594,765 B2 are based on a centralized repository and control point providing authorization to the agents. The devices containing an agent communicate only with the remote server and not between each other. So, it can only be prevented that the device works in an undefined or wrong environment.

Starting from the disadvantages and shortcomings as described above and taking the prior art as discussed into account, an object of the present invention is to further develop a security system of the kind as described in the technical field and a method of the kind as described in the technical field in such way that manipulation of the arrangement comprising multiple components or devices is prevented, in particular that
the usage of at least one undefined and/or unauthorized and/or illegal component or device in the arrangement and/or
the removal of at least one of the components or devices of the arrangement
is prevented.

The object of the present invention is achieved by a security system comprising the features of claim 1 as well as by a method comprising the features of claim 6. Advantageous embodiments and expedient improvements of the present invention are disclosed in the respective dependent claims.

The present invention is based on the idea of integrity protection of at least an open multiple component system or multiple device system, like at least one computer, at least one network, etc. against illegal, undesired and/or unauthorized manipulations, in particular against inserting and/or removing one or more components or devices. According to the teaching of the present invention, this integrity protection is realized by using at least one security unit, in particular at least one security module, for example at least one smart module or at least one smart card.

Thus, the security system according to the present invention as well as the method according to the present invention are designed for protecting the arrangement comprising multiple devices, for example against illegal hardware copies.

In order to protect the integrity of the arrangement, in particular of at least one complex system, like at least one computer, at least one network, etc. the present invention proposes
to perform at least one authentication, in particular at least one security check,
to provide each device with the security unit, in particular with at least one smart module integrated on-board so as to verify the presence of authentic cards, and/or
to take care of undefined and/or unauthorized and/or illegal hardware copies or hardware manipulation.

The present invention leads to the advantage that the use of undefined and/or unauthorized and/or illegal devices, in particular of undefined and/or unauthorized and/or illegal components or of undefined and/or unauthorized and/or illegal cards, can be detected.

According to a preferred embodiment of the present invention, in case of detecting such undefined and/or unauthorized and/or illegal devices the security unit is designed to disable the operation of its respective device and/or of the other devices, in particular when starting up.

Independently thereof or in combination therewith, according to a preferred embodiment of the present invention all other devices, i.e. the complete rest of the arrangement comprising multiple devices stops to work when an undefined and/or unauthorized and/or illegal device, in particular an undefined and/or unauthorized and/or illegal card, is detected, for example when at least one device without such embedded security system is inserted into the arrangement. Thus, the entire arrangement, in particular the entire network or the entire computer, can stop working in case of illegal usage.

Consequently, a preferred embodiment of the present invention is designed in order to prevent
that so-called piracy hardware, i.e. hardware created without any license of the original manufacturer, still works in another arrangement, and
that the arrangement of multiple devices where such piracy hardware has been installed into still works.

Independently thereof or in combination therewith, according to a preferred embodiment of the present invention every device of the arrangement is designed for mutual authentication. Hence, every device of the arrangement supports at least one mutual authentication scheme, which is preferably provided by the respective security unit, wherein the security unit in turn is assigned to, in particular embedded in, the respective device.

For authentication, preferably every device comprises, in particular stores by means of at least one storage unit, at least one predefined authentication profile defining under which conditions the authentication is to be assumed as being valid, in particular
under which conditions the device shall work and
under which conditions the device shall not work.

Advantageously the storage unit can further be designed for storing authentication information regarding the other devices, in particular authentication means for the other devices.

With
the security mechanism implemented by the security unit preferably being widely distributed over the entire arrangement of multiple devices and/or
each individual device preferably storing its own security profile and/or authentication means for the other devices,

according to a preferred embodiment of the present invention the security system does not require any remote server.

Consequently, in an expedient embodiment of the present invention a remote server is not obligatory because the security units are distributed over the security system. Thus, the present invention provides a decentralized security system, in which a connection to a centralized repository and control point is not required.

The main advantage of applying the paradigm of a decentralized security scheme is that such decentralized security scheme is much stronger than a centralized security scheme, and consequently it is much harder to cheat or to circumvent the decentralized security system being based on the decentralized security scheme.

Moreover, according to a preferred embodiment of the present invention, each individual device or component comprises, in particular stores in its respective memory module, the predefined security profile of the entire arrangement; thereby, the respective individual device is able
to verify other devices against this predefined security profile and/or
to disable itself and/or
to advise other connected devices to stop operation in case of an invalid authentication.

Favorably, every component or device of the arrangement comprising multiple components or multiple devices attempts to authenticate the, in particular all, other components or devices being comprised by the entire arrangement. In this manner every component or device in the arrangement receives and/or comprises a present existing authentication profile.

Authentication can for example be invalid if the present existing authentication profile does not match the predefined authentication profile, and consequently the devices can be advised to refuse to work by the security system, in particular by the respective security unit.

The predefined authentication profile can for example define that the devices of the arrangement shall only work if the security system, in particular the respective security unit, authenticates these devices exactly according to a predefined list of further arrangement devices. Advantageously, the arrangement comprising multiple devices does not work if the security system, in particular the security unit, detects any undefined and/or unauthorized and/or illegal device in the arrangement or if a required device is not present in the arrangement.

Preferably, this authentication profile is applied for all devices of the arrangement in order to protect the arrangement against undesired, for instance undefined and/or unauthorized and/or illegal, modifications of its devices.

According to a further advantageous embodiment, the security unit is designed for providing its respective device with a key functionality as a service in case of a valid authentication, in particular if the pre-defined authentication profile has been fulfilled. This service can be implemented by using the technical principle of R[emote]M[ethod]I[nvocation].

In this context, by R[emote]M[ethod]I[nvocation] objects on different computers can interact in a distributed network by using object-oriented programming, in particular by using Java programming language and development environment (Java RMI is a mechanism allowing to invoke a method on an object existing in another address space; the other address space can be on the same machine or on a different machine).

In other words, the RMI mechanism is basically an object-oriented R[emote]P[rocedure]C[all] mechanism with the ability to pass one or more objects along with the request. The object can include information that will change the service being performed in the remote computer.

Moreover, according to a favorable embodiment of the present invention all devices authenticate each other, in particular by means of the respective security units, wherein the respective device, in particular the respective security unit, refusing the authentication of another device, in particular of another security unit, starts to advise all other devices, in particular all other security units, to stop operation.

The present invention leads to the advantage that although the security units of the respective devices protect the execution of the key functionality of the respective devices and thus of the arrangement comprising the devices, the protection mechanism of the security system cannot be sidestepped by replacing the authorized or original device by at least one undefined and/or unauthorized and/or illegal, for instance faked, device implementing the same functionality as the authorized or original device.

A further advantage of the present invention, is the basic ability to be integrated into existing standards or into existing infrastructures.

In this context, components or devices which do not comprise any security unit according to the present invention and/or in which the security method according to the present invention has not been implemented, can be affected and/or modified by adding at least one component or device, for example by inserting or plugging in a P[eripheral]C[omponent]I[nterconnect] card, comprising such security unit and/or having such security method implemented.

Then, the functional and/or technical behaviour, reaction or response of the complete arrangement comprising such multiple components or devices cannot be predicted because the coordination and/or interaction between the unsecured component(s) or device(s) with the secured component(s) or device(s) cannot be anticipated.

In particular, a component or device, for example a P[eripheral]C[omponent]I[nterconnect] card, comprising such security unit according to the present invention and/or supporting such security method according to the present invention, may be designed such that this secure component or device strives to bug or disturb the functional and/or technical operation of the components or devices which do not comprise any security unit according to the present invention and/or in which the security method according to the present invention has not been implemented, for example by disregard of specifications or standards.

By such design, an abnormal end or even a crash of the function of the complete arrangement comprising the multiple components or devices can be volitionally evoked in order to unveil the fact that one or more of the multiple components or devices of the arrangement has not been implemented in compliance with the security principles of the teaching of the present invention.

The present invention finally relates to the control of computer systems and of other types of electrical, mechanical or electro-mechanical arrangements at the device or component level; such arrangement comprising multiple devices is secured by, in particular embedding, at least one security unit within each device of the arrangement in order to control access to the devices within the respective arrangement.

More specifically, the present invention relates to the use of at least one security system as described above and/or of the method as described above
for protecting at least one computer component, in particular at least one component of a desktop computer or of a notebook, against unauthorized usage in a different computer system, for example in order to prevent the usage of at least one plug-in card in at least one undefined and/or unauthorized personal computer, and/or
for protecting at least one computer system, in particular at least one desktop computer or at least one notebook, against unauthorized usage of at least one computer component, for example in order to prevent the usage of at least one undefined and/or unauthorized plug-in card in a computer main board, and/or
for protecting at least one computer network against usage of at least one undefined and/or unauthorized network adapter device, for example in order to prevent the usage of at least one undefined and/or unauthorized network adapter card, because the usage of the undefined and/or unauthorized network adapter card could force a crash of the entire computer network.

As already discussed above, there are several options to embody as well as to improve the teaching of the present invention in an advantageous manner. To this aim, reference is made to the claims respectively dependent on claim 1 and on claim 6; further improvements, features and advantages of the present invention are explained below in more detail with reference to two preferred embodiments by way of example and to the accompanying drawings where

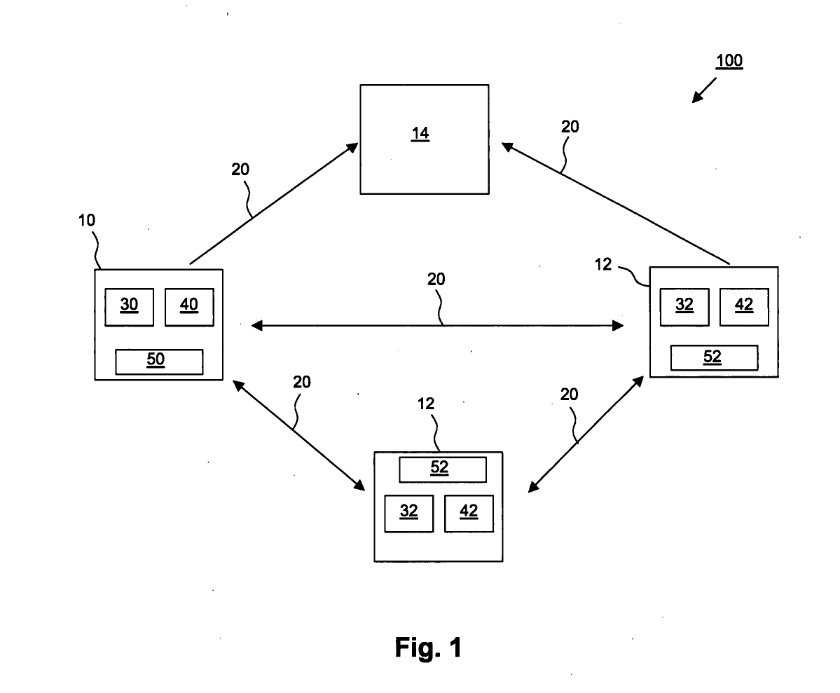

FIG. 1 schematically shows a first embodiment of security system according to the present invention working in compliance with the method of the present invention;

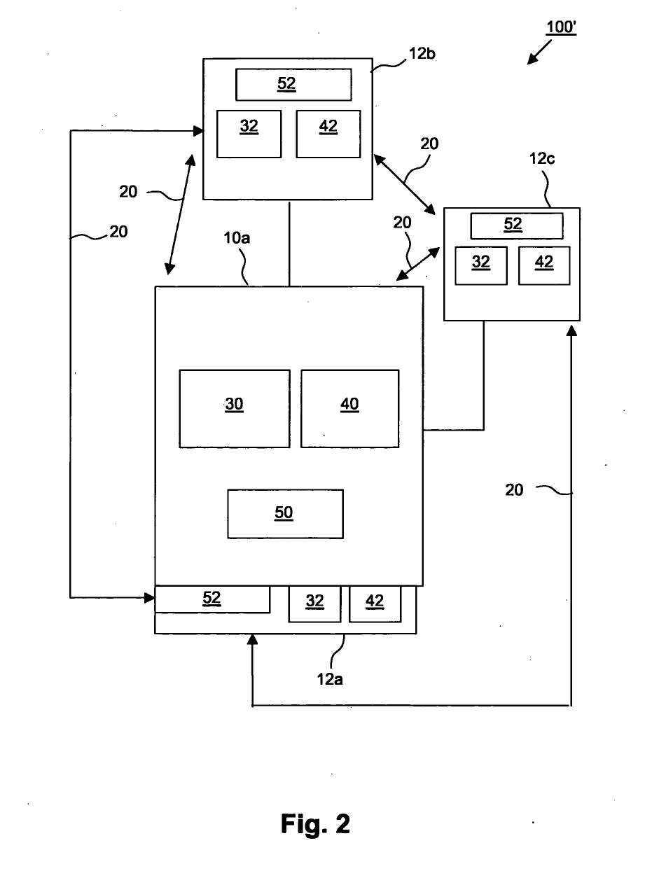

FIG. 2 schematically shows a second embodiment of security system according to the present invention working in compliance with the method of the present invention; and

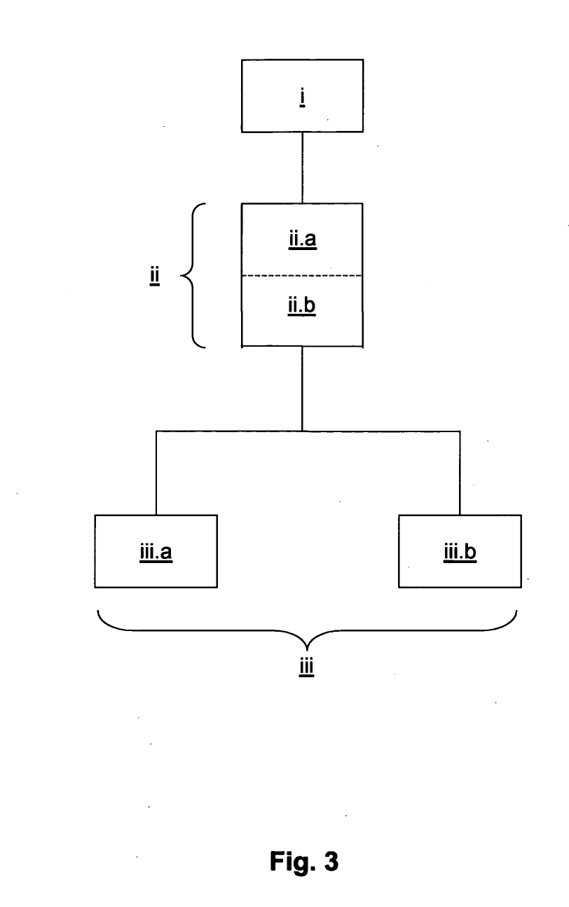

FIG. 3 shows a flow chart depicting an embodiment of the method according to the present invention.

The same reference numerals are used for corresponding parts in FIG. 1 to FIG. 3.

In order to avoid unnecessary repetitions, the following description regarding the embodiments, characteristics and advantages of the present invention relates (unless stated otherwise)
to the first embodiment of the security system 100 according to the present invention (cf. FIG. 1) as well as
to the second embodiment of the security system 100′ according to the present invention (cf. FIG. 2),

both embodiments 100, 100′ being operated according to the method of the present invention.

FIG. 1 shows a security system 100 designed for securing an arrangement comprising multiple devices 10, 12, namely a network comprising multiple personal computers 10, 12.

In this arrangement described by way of example, a respective security unit 30, 32, in particular a respective agent, is embedded in each device 10, 12; by the respective security unit 30, 32 the operation of the respective device 10, 12 is disabled when starting up.

Each security unit 30, 32 communicates to all other security units 30, 32 by exchanging a number of messages 20 to authenticate each other. For exchanging messages 20 and/or for being provided with a mutual authentication scheme and/or with a key functionality in case of a valid authentication, in particular by using R[emote]M[ethod]I[nvocation], each device comprises a respective interface 50, 52.

Possible interfaces 50, 52 may be
wireless communication channels (cf. first embodiment according to FIG. 1) or
contacted communication channels (cf. second embodiment according to FIG. 2),

in particular interfaces in accordance with the ISO/IEC 14443 standard (contactless), in accordance with the ISO/IEC 7816 standard (contacted) and U[niversal]S[erial]B[us].

For storing
the information comprised in the exchanged messages 20,
a secret key required for authentication as well as
a predefined authentication profile, each device 10, 12 comprises a respective memory or storage unit 40, 42.

When authorized, i.e. when authentication is valid, operation of the devices 10, 12 is enabled; otherwise, i.e. when authentication is invalid, operation of the devices 10, 12 is disabled.

Every component or device 10, 12 supports the mutual authentication scheme being provided by its respective embedded security unit 30, 32. For authentication, all security units 30, 32 authenticate each other by mutual authentication wherein one of the security units 30, 32 refusing the authentication of another device 14 not comprising such security unit 30, 32 starts to advise all other devices 10, 12 to stop operation.

In FIG. 2, a second embodiment of a security system 100′ according to the present invention is depicted.

This security system 100′ is designed for securing an arrangement being a compilation of multiple devices 10a, 12a, 12b, 12c, namely for securing a personal computer, for example a desktop computer or a notebook, comprising a main board 10a, a card slot for a plug-in card 12a, a display screen 12b and a computer mouse 12c.

Each device 10a, 12a, 12b, 12c comprises a security unit 30, 32 and a storage unit 40, 42. The security system 100′ described by way of example in FIG. 2 is assigned to an arrangement comprising multiple devices 10a, 12a, 12b, 12c being all valid, i.e. original or authenticated.

There are several possibilities to integrate the security unit 30, 32, for example being implemented as a smart card I[ntegrated]C[ircuit]
into an arrangement comprising the multiple devices 10, 12, like a network (cf. first embodiment according to FIG. 1) or
into an arrangement comprising multiple devices 10a, 12a, 12b, 12c, like a computer system (cf. second embodiment according to FIG. 2).

The security unit 30, 32 can for example be based on a secure N[ear]F[ield]C[ommunication] chip with an I[ntegrated]C[ircuit] being integrated in a device housing or in a P[rinted]C[circuit]B[oard] of the respective device 10, 12 (cf. first embodiment according to FIG. 1) or 10a, 12a, 12b, 12c (cf. second embodiment according to FIG. 2).

In this context, Near Field Communication (NFC)—standardized in ISO/IEC 18092—is an interface technology for exchanging data between consumer electronic devices 10, 12 (cf. first embodiment according to FIG. 1) or 10a, 12a, 12b, 12c (cf. second embodiment according to FIG. 2), like P[ersonal]C[computer]s and mobile phones, at a distance of typically ten centimetres.

N[ear]F[ield]C[ommunication] operates in the 13.56 Megahertz frequency range. As NFC compliant devices 10, 12 (cf. first embodiment according to FIG. 1) or 10a, 12a, 12b, 12c (cf. second embodiment according to FIG. 2) are brought close together they detect the other device and begin to determine how they can interact in terms of transferring data.

For example, bringing a NFC enabled camera close to a T[ele]V[ision] apparatus fitted with the same technology could initiate a transfer of images while a P[ersonal]D[igital]A[ssistent] and a computer will know how to synchronize address books or a mobile phone and an MP3 player will be able to initiate the transfer of music files.

Using NFC, consumers can quickly establish wireless links between devices 10, 12 (cf. first embodiment according to FIG. 1) or 10a, 12a, 12b, 12c (cf. second embodiment according to FIG. 2). NFC provides a more natural method for connecting and interacting with multiple devices broadening the scope of networking applications.

In case the devices 10, 12 (cf. first embodiment according to FIG. 1) or 10a, 12a, 12b, 12c (cf. second embodiment according to FIG. 2) are implemented as secure NFC chips, the NFC I[ntegrated]C[ircuit] stores the authentication profile and the secret key required for the mutual authentication scheme. Moreover, the NFC IC implements parts of the key functionality of the arrangement, in particular of the system components.

In FIGS. 1 and 2, contactless interfaces 50, 52 are used for the mutual authentication scheme. The galvanic interfaces 50, 52 are used to provide the mutual authentication scheme as well as the key functionality of the devices 10, 12 (cf. first embodiment according to FIG. 1) or 10a, 12a, 12b, 12c (cf. second embodiment according to FIG. 2) only in case of a successful authentication profile match.

Another possibility to embody the security system 100, 100′ according to the present invention is a contact smart card fixed on the P[rinted]C[ircuit]B[oard] of the network access devices.

According to this implementation the security unit 30, 32 is based on a smart card IC. This integrated circuit is located on the printed circuit board of the device 1010, 12 (cf. first embodiment according to FIG. 1) or 10a, 12a, 12b, 12c (cf. second embodiment according to FIG. 2). The smart card IC stores the authentication profile and the secret key required for the mutual authentication scheme. The smart card IC implements parts of the key functionality of the arrangement comprising the system components.

Advantageously, existing system busses being available (for instance U[niversal]S[erial]B[us], P[eripheral]C[omponent]I[nterconnect] or I[ndustry]S[tandard]A[rchitecture] bus in case of a computer system) are re-used for authentication purpose.

Finally, FIG. 3 depicts the respective steps of an embodiment of the method according to the present invention.

For securing the integrity of the arrangement comprising the multiple devices, for example of a network (cf. first embodiment according to FIG. 1) and/or of a computer system (cf. second embodiment according to FIG. 2), the devices 10, 12 or 10a, 12a, 12b, 12c communicate (reference numeral i in FIG. 3) with each other by exchanging the messages 20 between and among each other.

By means of the respective security unit 30, 32, the devices 10, 12 (cf. first embodiment according to FIG. 1) or 10a, 12a, 12b, 12c (cf. second embodiment according to FIG. 2) perform a mutual authentication (reference numeral ii in FIG. 3) wherein this step ii of performing the authentication comprises

calculating a current authentication profile based on the information delivered by the exchanged messages 20 (reference numeral ii.a in FIG. 3) and

comparing the current authentication profile with a predefined authentication profile defining under which conditions the authentication is valid (reference numeral ii.b in FIG. 3).

In case of a valid authentication the operation of the respective device 10 or 10a and/or of at least one of the other devices 12 or 12a, 12b, 12c is enabled (reference numeral iii.a in FIG. 3) wherein this step iii.a of enabling the operation of the respective device 10 or 10a and/or of at least one of the other devices 12 or 12a, 12b, 12c is controlled by providing the respective device 10 or 10a and/or the at least one of the other devices 12 or 12a, 12b, 12c with the key functionality.

Otherwise, i.e. in case of an invalid authentication, the operation
of the respective device 10 or 10a and/or
at least one of the other devices 12 or 12a, 12b, 12c and/or
of an undefined and/or unauthorized and/or illegal device 14 is disabled (reference numeral iii.b in FIG. 3).

The step iii.b of disabling the operation of the respective device 10 or 10a and/or of at least one of the other devices 12 or 12a, 12b, 12c and/or of the undefined and/or unauthorized and/or illegal device 14 is controlled by denying the respective device any key functionality.

### LIST OF REFERENCE NUMERALS

100 security system (=first embodiment; cf. FIG. 1)
100′ security system (=second embodiment; cf. FIG. 2)
10 device, in particular respective device, of security system 100 (=first embodiment; cf. FIG. 1)
10a device, in particular respective device, of security system 100′ (=second embodiment; cf. FIG. 2)
12 other device, in particular further device, of security system 100 (=first embodiment; cf. FIG. 1)
12a first other device, in particular card slot for plug-in card, of security system 100′ (=second embodiment; cf. FIG. 2)
12b second other device, in particular display screen, of security system 100′ (=second embodiment; cf. FIG. 2)
12c third other device, in particular computer mouse, of security system 100′ (=second embodiment; cf. FIG. 2)
14 undefined and/or unauthorized device, in particular device without security unit
20 messages between and among the devices 10, 12
30 security unit of device 10
32 security unit of other device 12
40 memory unit or storage unit of device 10, in particular I[ntegrated]C[ircuit] of a smart card or of a N[ear]F[ield]C[ommunication] chip being assigned to device 10
42 memory unit or storage unit of other device 12, in particular I[ntegrated]C[ircuit] of a smart card or of a N[ear]F[ield]C[ommunication] chip being assigned to further device 12
50 interface unit of device 10
52 interface unit of other device 12

1. A security system for securing the integrity of at least one arrangement comprising multiple devices, for example of at least one network and/or of at least one computer system, characterized in
that the devices communicate with each other, in particular by exchanging messages between and among each other,
that each device comprises at least one respective security unit
[a] for performing at least one authentication by means of exchanged messages and
[b.i] in case of a valid authentication for enabling operation of the respective device and/or of at least one of the other devices and
[b.ii] otherwise, in particular in case of an invalid authentication, for disabling operation
of the respective device and/or
of at least one of the other devices and/or
of at least one undefined and/or unauthorized device in particular of at least one device comprising no such security unit

2. The security system according to claim 1, characterized in that each device comprises at least one storage unit for storing
at least one predefined authentication profile defining under which conditions the authentication is to be assumed as valid, wherein the predefined authentication profile for example defines the kind and/or the identity and/or the number of the devices being comprised by the arrangement to be secured; and/or
at least one secret key, particularly required for at least one mutual authentication scheme; and/or
authentication information regarding the other devices, in particular authentication means for the other devices.

3. The security system according to claim 1 characterized in that the security unit is designed for providing its respective device, in particular via at least one interface unit,
with the mutual authentication scheme and/or
with at least one key functionality in case of a valid authentication, in particular by using R[emote]M[ethod]I[nvocation].

4. The security system according to claim 1, characterized in
that the security unit is embedded in its respective device and
that the security unit disables the operation of its respective device and/or of the other devices when starting up.

5. The security system according to claim 1, characterized in that all devices authenticate each other, in particular by means of the respective security units, wherein the respective device, in particular the respective security unit refusing the authentication of another device, in particular of another security unit, starts to advise all other devices, in particular all other security units, to stop operation.

6. A method for securing the integrity of at least one arrangement comprising multiple devices, for example of at least one network and/or of at least one computer system, characterized in
(i) that the devices communicate with each other, in particular by exchanging messages between and among each other,
(ii) that at least one authentication is performed by means of the exchanged messages and
(iii) that the operation
of the respective device and/or
of at least one of the other devices and/or
of at least one undefined and/or unauthorized device
(iii.a) is enabled in case of a valid authentication and
(iii.b) is disabled otherwise, in particular in case of an invalid authentication.

7. The method according to claim 6, characterized in that the step (ii) of performing the authentication comprises
(ii.a) calculating at least one current authentication profile based on the information delivered by the exchanged messages and
(ii.b) comparing the current authentication profile with at least one predefined authentication profile defining under which conditions the authentication is valid.

8. The method according to claim 6, characterized in
that the device is provided with at least one mutual authentication scheme and/or
that
enabling (iii.a) the operation of the respective device and/or of at least one of the other devices is controlled by providing the respective device with at least one key functionality and
disabling (iii.b) the operation of the respective device and/or of at least one of the other devices and/or of the undefined and/or unauthorized device is controlled by denying the respective device any key functionality.

9. The method according to claim 6, characterized in that authentication is performed for all devices, in particular by means of at least one respective security unit, wherein the respective device, in particular the respective security unit refusing the authentication of another device, in particular of another security unit, advises all other devices, in particular all other security units, to stop operation.

10. Use of at least one security system according to claim 1
for protecting at least one computer component, in particular at least one component of a desktop computer or of a notebook, against unauthorized usage in a different computer system, for example in order to prevent the usage of at least one plug-in card in at least one undefined and/or unauthorized personal computer, and/or
for protecting at least one computer system, in particular at least one desktop computer or at least one notebook, against unauthorized usage of at least one computer component, for example in order to prevent the usage of at least one undefined and/or unauthorized plug-in card in a computer main board, and/or
for protecting at least one computer network against usage of at least one undefined and/or unauthorized network adapter device, for example in order to prevent the usage of at least one undefined and/or unauthorized network adapter card.
